(19) United States
(12) Patent Application Publication
(10) Pub. No.: US 2003/0164034 A1
(43) Pub. Date: Sep. 4, 2003

(54) System and method for using a saw based RF transmitter for FM transmission in a TPM

(75) Inventors: John S. Nantz, Brighton, MI (US); Qingfeng Tang, Novi, MI (US); Ronald O. King, Brownstown, MI (US); Riad Ghabra, Dearborn Heights, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI

(21) Appl. No.: 10/321,933

(22) Filed: Dec. 17, 2002

Related U.S. Application Data
(60) Provisional application No. 60/360,762, filed on Mar. 1, 2002.

(51) Int. Cl. E01C 23/00; G01M 17/02

(52) U.S. Cl. 73/146

(57) ABSTRACT

For use in a tire pressure monitoring system, a frequency modulation (FM) radio frequency (RF) oscillator includes a modulator and a generator. The modulator may be configured to generate a modulation signal in response to a data input signal. The generator may be configured to generate an FM output signal having a carrier frequency modulated by the modulation signal, wherein the generator includes a frequency determining device.

### CROSS-REFERENCE TO RELATED APPLICATION

This application claims the benefit of U.S. provisional application Serial No. 60/360,762 filed Mar. 1, 2002.

### BACKGROUND OF THE INVENTION

1. Field of the Invention

The present invention relates to a system and a method for using a surface acoustic wave (SAW) based radio frequency (RF) transmitter for frequency modulation RF transmission in a tire pressure monitoring system.

2. Background Art

It is known in the automotive industry to provide for wireless monitoring of vehicle tire parameters, particularly tire pressure. In some such tire pressure monitoring (TPM) systems, tire pressure sensors and radio frequency (RF) transmitters that can generate and transmit at least one frequency modulated (FM) signal. In each tire, the tire pressure sensed by the tire pressure sensor is transmitted by the transmitter through an antenna to a receiver/controller located on the vehicle. The tire pressure information delivered to the receiver/controller by the RF FM signals from the transmitters is subsequently conveyed to a vehicle operator or occupant, typically using a display unit. In such a fashion, tire pressure monitoring systems can help to improve vehicle safety. Exemplary tire pressure monitoring systems are described and shown in U.S. Pat. Nos. 6,112,587 and 6,034,597.

Remote keyless entry (RKE) systems are also well known in the automotive industry. Some RKE systems can include a conventional RF FM transmitter used by the vehicle operator or occupant to transmit signals that control such functions as door, trunk, etc. locking/unlocking, turning on/off lights, sounding an alert, arming/disarming an anti-theft system, etc. and a receiver/controller in the vehicle that processes the transmitter control signals.

However, conventional FM transmitters that are not based on surface acoustic wave (SAW) technology (i.e., non-SAW FM transmitters) can be limited to transmission of lower data rates than is desired for some tire pressure monitoring, RKE, and other applications. Furthermore, some conventional SAW based FM transmitters have two or more transistors to generate the frequency modulation for the RF signal. As a result, conventional approaches for FM transmitters can be costly and can have significant circuit board size and weight.

Thus, there exists a need for a system and a method for a SAW based RF transmitter to provide FM signal modulation generation in a single transistor configuration. Such a system and method would generally provide fewer components and hence be less costly than conventional approaches. Such a system and method would generally provide the desired data rates for applications such as TPM and RKE systems.

### SUMMARY OF THE INVENTION

Accordingly, the present invention provides an improved system and an improved method for a surface acoustic wave (SAW) based radio frequency (RF) transmitter to provide frequency modulation (FM) signal modulation generation in a single transistor configuration. The present invention may be advantageously implemented in connection with a tire pressure monitoring (TPM) system, a remote keyless entry (RKE) system, or the like.

According to the present invention, for use in a tire pressure monitoring system, a frequency modulation (FM) radio frequency (RF) oscillator is provided comprising a modulator and a generator. The modulator may be configured to generate a modulation signal in response to a data input signal. The generator may be configured to generate an FM output signal having a carrier frequency modulated by the modulation signal, wherein the generator comprises a frequency determining device.

Also according to the present invention, for use in a tire pressure monitoring system, a method of generating a frequency modulation (FM) radio frequency (RF) output signal is provided, the method comprising generating a modulation signal in response to a data input signal, generating an RF signal having a carrier frequency, and frequency modulating the carrier frequency of the RF signal with the modulation signal, wherein the RF signal is generated using a generator comprising a frequency determining device.

Further, according to the present invention, for use in a remote keyless entry (RKE) system, a frequency modulation (FM) radio frequency (RF) oscillator is provided comprising a modulator and a generator. The modulator may be configured to generate a modulation signal in response to a data input signal. The generator may be configured to generate an FM output signal having a carrier frequency modulated by the modulation signal, wherein the generator comprises a surface acoustic wave (SAW) device.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of a frequency modulation oscillator according to the present invention; and

FIG. 2 is a detailed diagram of the frequency modulation oscillator of FIG. 1.

### DETAILED DESCRIPTION OF THE PREFERRED EMBODIMENT(S)

With reference to the Figures, the preferred embodiments of the present invention will now be described in detail. As previously noted, it is known in the automotive industry to provide for wireless monitoring of vehicle tire parameters, particularly tire pressure. In some such tire pressure monitoring (TPM) systems, tire pressure sensors and radio frequency (RF) transmitters that can generate and transmit at least one frequency modulated (FM) signal. In each tire, the tire pressure sensed by the tire pressure sensor is transmitted by the transmitter through an antenna to a receiver/controller located on the vehicle. The tire pressure information delivered to the receiver/controller by the RF FM signals from the transmitters is subsequently conveyed to a vehicle operator or occupant, typically using a display unit.

Furthermore, remote keyless entry (RKE) systems are also well known in the automotive industry. Some RKE systems include a conventional RF FM transmitter used by the vehicle operator or occupant to transmit signals that control such functions as door, trunk, etc. locking/unlocking, turning on/off lights, sounding an alert, arming/disarming an anti-theft system, etc. and a receiver/controller in the vehicle that processes the transmitter control signals.

Generally, the present invention provides an improved system and an improved method for a surface acoustic wave (SAW) based RF transmitter oscillator to provide FM signal modulation generation in a single transistor configuration. Such a system and method are generally implemented having fewer components and may be less costly than conventional approaches. Such a system and method generally provide the desired data rates that may not be attainable using conventional approaches for applications such as TPM and RKE systems.

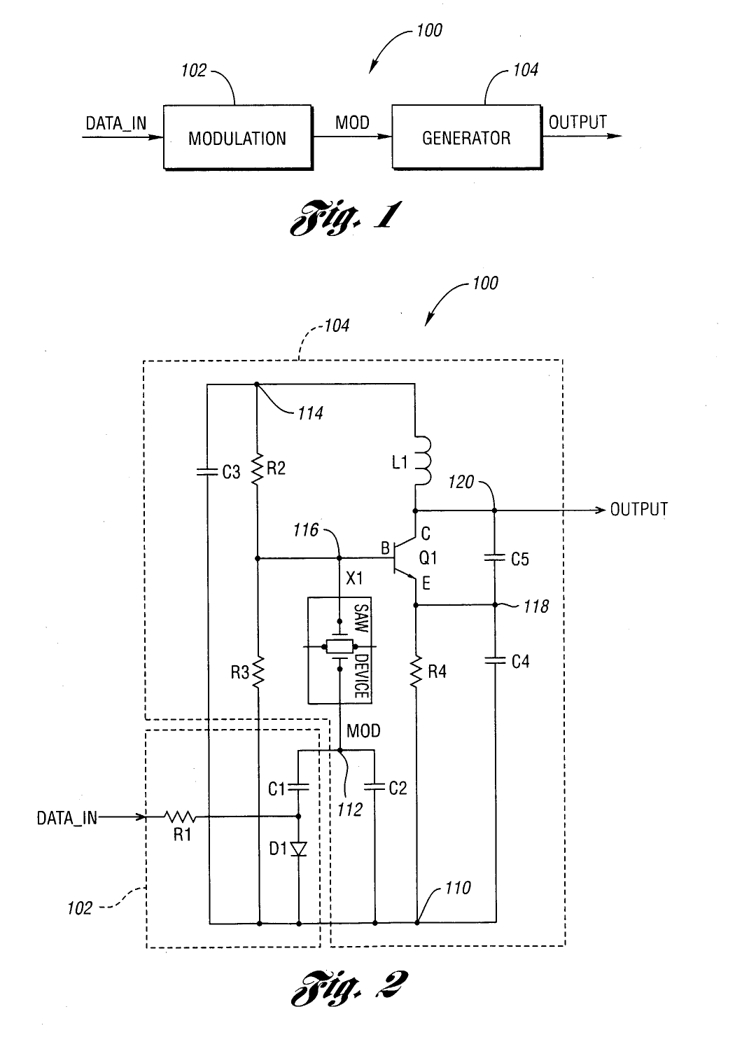

Referring to FIG. 1, a diagram illustrating a oscillator circuit 100 in accordance with a preferred embodiment of the present invention is shown. The oscillator 100 generally comprises a modulation circuit (or modulator) 102 that is configured to provide a frequency modulation (FM) signal (e.g., MOD) for modulation of a carrier frequency generated by an RF surface acoustic wave (SAW) based frequency generation circuit (or generator) 104 in response to a data input signal (e.g., DATA_IN) and, thereby, generate a frequency modulated RF output signal (e.g., OUTPUT). In one example, the oscillator 100 may be implemented in connection with a TPM system. In another example, the oscillator 100 may be implemented in connection with a RKE system. However, the oscillator 100 may be advantageously implemented in connection with any appropriate wireless transmission system to meet the design criteria of a particular application.

The modulator 102 may have an input that may receive the signal DATA_IN and an output that may present the signal MOD. The RF generator 104 may have an input that may receive the signal MOD and an output that may present the signal OUTPUT. In one example, the generator 104 may be configured as a Colpitts oscillator. However, the generator 104 may be implemented (or configured) as any appropriate RF oscillator to meet the design criteria of a particular application.

The signal DATA_IN is generally data (or information) that is modulated onto a carrier wave having a radio frequency (RF). The signal OUTPUT is generally an FM RF signal where the frequency modulation corresponds to the signal (or information related to the signal) DATA_IN. The circuit 100 may be configured to generate the signal OUTPUT in response to the signal DATA_IN. The signal OUTPUT is generally coupled to an amplifier, antenna, load, or other appropriate component or circuitry (not shown) to meet the design criteria of a particular application.

Referring to FIG. 2, a detailed diagram of the oscillator 100 is shown. The oscillator 100 generally comprises resistances (or resistors) R1, R2, R3 and R4, capacitances C1, C2, C3, C4 and C5, a diode D1, an element (or device) X1, an inductance L1, and a device (or transistor) Q1. Some components of the oscillator 100 are generally connected to form a number of nodes (e.g., nodes 110, 112, 114, 116, 118, and 120) as described below.

In one example, the capacitances C1-C5 may be implemented as capacitors. In another example, the capacitances C1-C5 may be implemented as transistors configured as capacitors. However, the capacitances C1-C5 may be implemented as any appropriate capacitive components to meet the design criteria of a particular application. In one example, the diode D1 may be implemented as a bi-polar component. In another example, the diode D1 may be implemented as at least one transistor configured as a diode.

The element X1 is generally implemented as a surface acoustic wave (SAW) device that is configured to have a predetermined (e.g., set, fixed, stable, etc.) oscillation frequency in response to a given input (e.g., a particular input current or voltage). However, the element X1 may be implemented as any appropriate frequency determining device, network, circuitry, etc. (e.g., LC components, a crystal resonator, a ceramic resonator, etc.) to meet the design criteria of a particular application. The transistor Q1 is generally implemented as a bipolar junction transistor (BJT). However, the device Q1 may be implemented as any appropriate device (e.g., an FET) to meet the design criteria of a particular application.

The modulator 102 generally comprises the resistor R1, the diode D1, and the capacitance C1. A first terminal of the resistance R1 may receive the signal DATA_IN. The resistance R1 may have a second terminal that may be connected to a first terminal of the capacitance C1 and a first terminal (e.g., an anode terminal) of the diode D1. The diode D1 may have a second terminal (e.g., a cathode terminal) that may be connected to the node 110. The capacitance C1 may have a second terminal that may be connected to the node 112. The signal MOD is generally presented at the node 112.

The generator 104 generally comprises the capacitances C2, C3, C4 and C5, the resistors R2, R3 and R4, the inductance L1, the device X1, and the transistor Q1 configured in combination to form a Colpitts oscillator. However, the generator 104 may be implemented as any appropriate oscillator configuration to meet the design criteria of a particular application.

The capacitance C2 may have a first terminal that may be connected to the node 110 and a second terminal that may be connected to the node 112. The capacitance C3 may have a first terminal that may be connected to the node 110 and a second terminal that may be connected to the node 114. The capacitance C4 may have a first terminal that may be connected to the node 110 and a second terminal that may be connected to the node 118. The capacitance C5 may have a first terminal that may be connected to the node 118 and a second terminal that may be connected to the node 120. The signal OUTPUT is generally presented at the node 120.

The resistor R2 may have a first terminal that may be connected to the node 114 and a second terminal that may be connected to the node 116. The resistor R3 may have a first terminal that may be connected to the node 110 and a second terminal that may be connected to the node 116. The resistor R4 may have a first terminal that may be connected to the node 110 and a second terminal that may be connected to the node 118.

The inductance L1 may have a first terminal that may be connected to the node 114 and a second terminal that may be connected to the node 120. The device X1 may have a first terminal that may be connected to the node 112 (e.g., a terminal that may receive the signal MOD) and a second terminal that may be connected to the node 116. The transistor Q1 may have a base that may be connected to the node 116, an emitter that may be connected to the node 118, and a collector that may be connected to the node 120 (e.g., a collector that may present the signal OUTPUT).

During one mode of operation of the oscillator 100 (e.g., an FM transmission, broadcast, or radiation mode), the signal DATA_IN is generally configured to control the frequency modulation of the signal OUTPUT. When the signal DATA_IN changes, current flow through the diode D1 generally changes and the effective parallel capacitance of the capacitances C1 and C2 changes accordingly. The signal MOD is generally adjusted in response to the signal DATA_IN. Since the device X1 generally sets (i.e., provides, fixes, establishes, generates, etc.) the carrier frequency of the signal OUTPUT, the signal MOD generally provides frequency modulation (e.g., “pulls the frequency”) to the signal OUTPUT as determined by the signal DATA_IN. The carrier frequency of the signal OUTPUT is generally frequency modulated by (or with) the signal MOD.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. For use in a tire pressure monitoring system, a frequency modulation (FM) radio frequency (RF) oscillator comprising:
a modulator configured to generate a modulation signal in response to a data input signal; and
a generator configured to generate an FM output signal having a carrier frequency modulated by the modulation signal, wherein the generator comprises a frequency determining device.

2. The oscillator of claim 1 wherein the modulator comprises a diode configured to generate the modulation signal in response to the input signal.

3. The oscillator of claim 1 wherein the frequency determining device comprises a surface acoustic wave (SAW) device.

4. The oscillator of claim 1 wherein the oscillator comprises a Colpitts oscillator.

5. The oscillator of claim 1 wherein the frequency determining device is a crystal resonator or a ceramic resonator.

6. The oscillator of claim 1 wherein the oscillator is implemented for use in a remote keyless entry (RKE) system.

7. The oscillator of claim 1 wherein the generator comprises a single transistor.

8. For use in a tire pressure monitoring system, a method of generating a frequency modulation (FM) radio frequency (RF) output signal, the method comprising:
generating a modulation signal in response to a data input signal;
generating an RF signal having a carrier frequency; and
frequency modulating the carrier frequency of the RF signal with the modulation signal, wherein the RF signal is generated using a generator comprising a frequency determining device.

9. The method of claim 8 comprising generating the modulation signal using a diode.

10. The method of claim 8 wherein the frequency determining device comprises a surface acoustic wave (SAW) device.

11. The oscillator of claim 8 wherein the output signal is generated using a Colpitts oscillator.

12. The method of claim 8 wherein the frequency determining device is a crystal resonator or a ceramic resonator.

13. The method of claim 8 wherein the method is implemented for use in a remote keyless entry (RKE) system.

14. The method of claim 8 comprising generating the output signal using a single transistor.

15. For use in a remote keyless entry (RKE) system, a frequency modulation (FM) radio frequency (RF) oscillator comprising:
a modulator configured to generate a modulation signal in response to a data input signal; and
a generator configured to generate an FM output signal having a carrier frequency modulated by the modulation signal, wherein the generator comprises a surface acoustic wave (SAW) device.

16. The oscillator of claim 15 wherein the modulator comprises a diode configured to generate the modulation signal in response to the input signal.

17. The oscillator of claim 15 wherein the SAW is configured to generate the carrier frequency and receive the modulation signal.

18. The oscillator of claim 15 wherein the oscillator comprises a Colpitts oscillator.

19. The oscillator of claim 15 wherein the oscillator is coupled to an amplifier or an antenna.

20. The oscillator of claim 15 wherein the generator comprises a single transistor.
